(19) United States
(12) Patent Application Publication
(10) Pub. No.: US 2010/0293173 A1
(43) Pub. Date: Nov. 18, 2010

(54) System and method of searching based on orientation

(76) Inventors: Charles Chapin, San Jose, CA (US); Stephane Lafon, Sunnyvale, CA (US); Augusto Roman, Mountain View, CA (US); Xinyu Tang, Cupertino, CA (US); Shalini Agarwal, New York, NY (US); Vibhor Nanavati, Sunnyvale, CA (US); Luc Vincent, Palo Alto, CA (US); Stephen Chau, Stanford, CA (US)

Correspondence Address: GOOGLE;Lerner, David, Littenberg, Krumholz & Mentlik, LLP, 600 South Avenue West, Westfield, NJ, 07090, US

(21) Appl. No.: 12/454,172

(22) Filed: May 13, 2009

(51) Int. Cl. G06F 17/30; G06F 7/00

(52) U.S. Cl. 707/759; 705/14.4; 707/803; 707/955; 707/769; 707/770; 707/957

(57) ABSTRACT

A system and method is provided whereby, in one aspect, advertisements are displayed based on search terms that were selected based on the angle at which a user is viewing a street level image.

### BACKGROUND OF THE INVENTION

Google Maps offers a variety of services related to searching maps. For example, a user may enter a street address or latitude/longitude position and view a map of the requested location. Geocoders are routines used to convert locations identified in accordance with one reference system into locations identified by another reference system. For example, a computer may convert street addresses to latitude/longitude positions and vice versa, such as converting “1600 Amphitheatre Parkway, Mountain View, Calif.” to “(latitude 37.4230210°, longitude −122.083939)”.

In addition to searching for locations, a user may also enter other search terms while viewing a map. For example, a user may search for “pizza” while viewing a map. In response, the service will provide search results such as listings that are proximate to the map and fall within the category of pizza restaurants (or otherwise match the request such as having the term “pizza” in their company name). The service may also return entities having other associations with the search term, such as advertisements from companies that paid to have their advertisements shown when a user queries one or more terms regardless of the map being viewed.

In certain circumstances, the service also stores an association between the search terms and the portion of the map being viewed by a first user. Also in certain circumstances, the terms are used, either alone or in combination with other prior user searches, to query and display advertisements when subsequent users view a portion of the map that overlaps with the prior portion.

Google Maps is also capable of displaying street level images of geographic locations. These images, identified in Google Maps as “Street Views”, typically comprise photographs of buildings and other geographic features and allow a user to view a geographic location from a person's perspective as compared to a top-down map perspective.

When a street level image is taken, it is typically associated with a location such as the latitude/longitude position of the camera. The street level image may also comprise a 360° panorama, such that the user may view the panorama—and the objects captured therein—from a variety of angles. The service also displays a street address to the user that is intended to approximate the closest street address to the location of the camera when the image was taken.

### BRIEF SUMMARY OF THE INVENTION

In one aspect, a method of providing advertisements for display includes receiving a request from a user and, in response to the request, providing an image of geographic objects captured by a camera at a camera location to be displayed on an electronic display apparatus associated with the user. The method further includes selecting, with a processor, a search term from among a plurality of search terms based on the orientation from which the image will be viewed by the user. It also selects an advertisement based on the selected search term. The advertisement is then provided for display on the electronic display apparatus.

In another aspect, a system is provided that includes a first computer at a first node of a network where the computer includes a processor and instructions operable by the processor. The first computer further has access to a plurality of street level images where each street level image is associated with the geographic location of the camera that took the street level image. The first computer also has access to a plurality of keywords where each keyword is associated with a geographic location. The system also includes a client device at a second node of the network where the client device includes a user input device, an electronic display, a processor and instructions operable by the processor. The instructions of the first computer include transmitting to the client device, via the network, a street level image and an advertisement selected based on the keywords. The keywords are selected based on whether their location corresponds with a viewing angle selected by a user at the second node to view the street level image. The instructions of the first computer include displaying the street level image and advertisement transmitted by the first computer on the electronic display.

Yet another aspect provides a method that includes: displaying an image of geographic objects on an electronic display from a viewing perspective, where the viewing perspective identifies both the location and the angle from which the objects are shown in the display; selecting, with a processor, a portion of a set of search terms based on a comparison of the viewing perspective with location information associated with each search term; and displaying a description with the image of geographic objects, where the selected description was selected from among a plurality of descriptions based on the selected search terms, and where each description is associated with at least one search term.

In still another aspect, a computer usable medium includes a program that includes: computer code that displays an image of geographic objects on an electronic display from a viewing perspective, where viewing perspective identifies both the location and angle from which the objects are shown in the display; computer code that selects a portion of a set of search terms based on a comparison of the viewing perspective with location information associated with each search term; and computer code that displays a description simultaneously with the image of geographic objects, where the selected description was selected from among a plurality of descriptions based on the selected search terms, and where each description is associated with at least one search term.

In yet a further aspect, a computer usable medium includes a program that includes: computer code that receives a request from a user; computer code that provides an image to be displayed on an electronic display associated with the user in response to the request, the image comprising geographic objects captured by a camera at a camera location; computer code that selects a search term from among a plurality of search terms based on the orientation from which the image will be viewed by the user; computer code that selects an advertisement based on the selected search term; and computer code that provides the advertisement to be displayed on the electronic display.

### BRIEF DESCRIPTION OF THE DRAWINGS

FIG. 1 is a functional diagram of a system in accordance with an aspect of the invention.

FIG. 2 is a pictorial diagram of a system in accordance with an aspect of the invention.

FIG. 3 is a diagram of the relative position of geographic objects to be processed in accordance with an aspect of the invention.

FIG. 4 is a diagram of an allocation of search terms associated with geographic objects in accordance with an aspect of the invention.

FIG. 5 is a diagram of an allocation of search terms associated with geographic objects in accordance with an aspect of the invention.

FIG. 6 is a screen shot in accordance with an aspect of the invention.

FIG. 7 is a screen shot in accordance with an aspect of the invention.

FIG. 8 is a diagram of a selection of search terms, based on orientation of a viewing angle in accordance with an aspect of the invention.

FIG. 9 is a diagram of a selection of search terms, based on orientation of a viewing angle in accordance with an aspect of the invention.

FIG. 10 is a screen shot in accordance with an aspect of the invention.

FIG. 11 is a diagram of an allocation of search terms associated with geographic objects in accordance with an aspect of the invention.

FIG. 12 is a diagram of screen shots and an allocation of search terms associated with geographic objects in accordance with an aspect of the invention.

FIG. 13 is a diagram of a selection of search terms, based on orientation of a viewing angle in accordance with an aspect of the invention.

FIG. 14 is a screen shot in accordance with an aspect of the invention.

FIG. 15 is a diagram of the selection of search terms, based on orientation of a viewing angle in accordance with an aspect of the invention.

FIG. 16 is a diagram of the selection of search terms, based on orientation of a viewing angle in accordance with an aspect of the invention.

FIG. 17 is a flowchart in accordance with an aspect of the invention.

FIG. 18 is a flowchart in accordance with an aspect of the invention.

FIG. 19 is a flowchart in accordance with an aspect of the invention.

### DETAILED DESCRIPTION

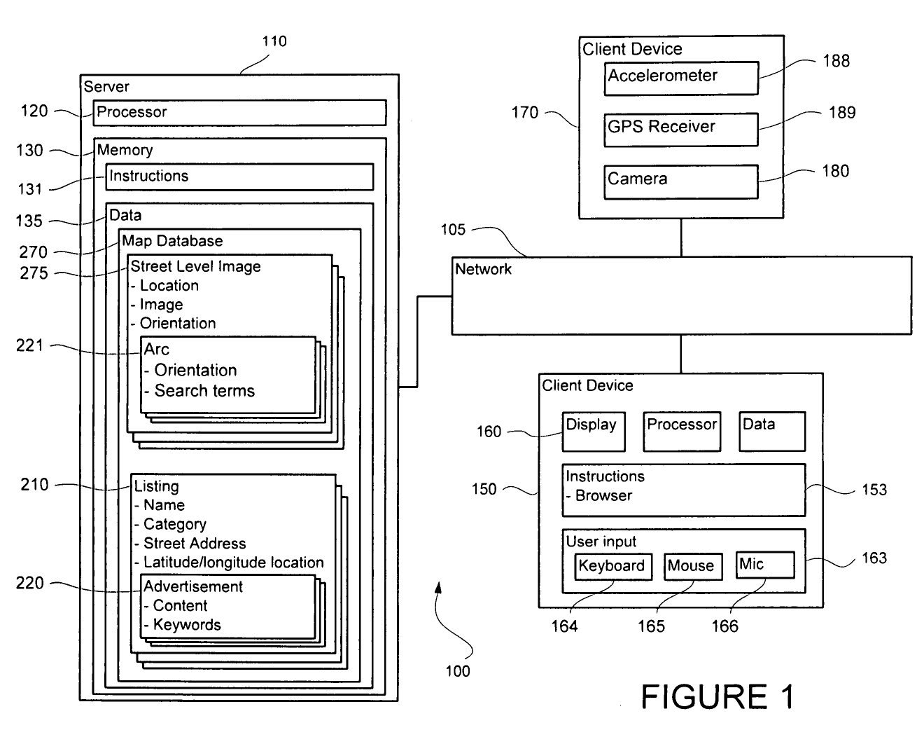

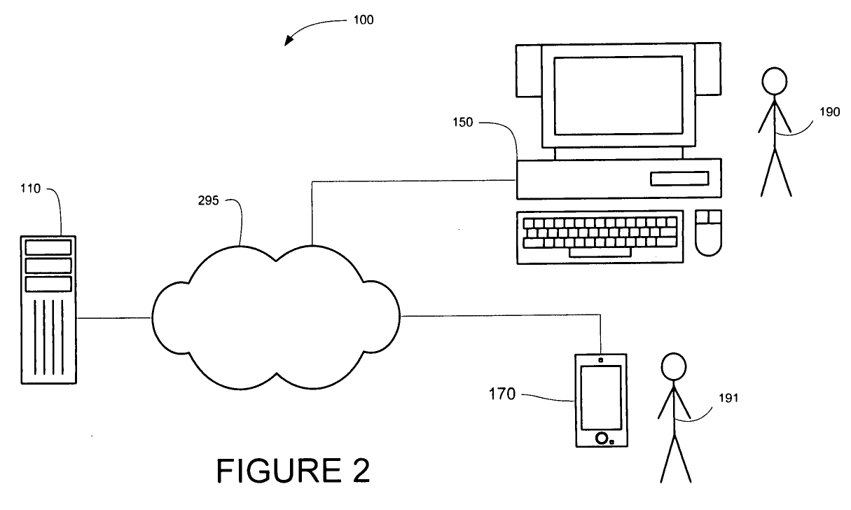

As shown in FIGS. 1-2, a system 100 in accordance with one aspect of the invention includes a computer 110 containing a processor 120, memory 130 and other components typically present in general purpose computers.

Memory 130 stores information accessible by processor 120, including instructions 131 that may be executed by the processor 120. It also includes data 135 that may be retrieved, manipulated or stored by the processor. The memory may be of any type capable of storing information accessible by the processor, including a computer-readable medium such as a hard-drive, memory card, ROM, RAM, DVD, or CD-ROM, as well as other write-capable and read-only memories. The processor 120 may be any well-known processor, such as processors from Intel Corporation or AMD. Alternatively, the processor may be a dedicated controller such as an ASIC.

The instructions 131 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

Data 135 may be retrieved, stored or modified by processor 120 in accordance with the instructions 131. For instance, although the system and method is not limited by any particular data structure, the data may be stored in computer registers, in a relational database as a table having a plurality of different fields and records, XML documents, or flat files. The data may also be formatted in any computer-readable format such as, but not limited to, binary values, ASCII or Unicode. By further way of example only, image data may be stored as bitmaps comprised of pixels that are stored in accordance with compressed or uncompressed, lossless (e.g., BMP) or lossy (e.g., JPEG), and bitmap or vector-based formats (e.g., SVG), as well as computer instructions for drawing graphics. The data may comprise any information sufficient to identify the relevant information, such as numbers, descriptive text, proprietary codes, pointers, references to data stored in other memories (including other network locations) or information that is used by a function to calculate the relevant data.

Although FIG. 1 functionally illustrates the processor and memory as being within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Similarly, references to a processor will be understood to include references to a collection of processors that may or may not operate in parallel.

In one aspect, computer 110 is a server communicating with one or more client devices 150 and 170. For example, computer 110 may be a web server.

Each client device may be configured similarly to the server 110, with a processor, memory and instructions. Each client device 150 and 170 may be a personal computer, intended for use by a person 190-191, having all the internal components normally found in a personal computer such as a central processing unit (CPU), display device 160 (for example, a monitor having a screen, a projector, a touch-screen, a small LCD screen, a television, or another device such as an electrical device that is operable to display information processed by the processor), DVD drive, hard-drive, user input 163 (for example, a mouse 165, keyboard 164, touch-screen or microphone 166), speakers, modem or network interface device (telephone, cable, wireless or otherwise), and all of the components used for connecting these elements to one another. Moreover, computers in accordance with the systems and methods described herein may comprise any device capable of processing instructions and transmitting data to and from humans and other computers including general purpose computers, PDAs, network computers lacking local storage capability, and set-top boxes for televisions.

Although the client devices 150 and 170 may comprise a full-sized personal computer, the system and method may also be used in connection with mobile devices capable of wirelessly exchanging data with a server over a network such as the Internet. For example, a client device 170 may be a wireless-enabled PDA such as a Blackberry phone or an Internet-capable cellular phone. The user may input information using a small keyboard (in the case of a Blackberry phone), a keypad (in the case of a typical cell phone), a touch screen (in the case of a PDA) or any other user input device.

The server 110 and client devices 150 and 170 are capable of direct and indirect communication, such as over a network 105. For example, server 110 may receive a search request from a client device such as client device 150. Processor 120 may execute search instructions and may use search data to obtain search results. Server 110 may send the search results to a client device for display to the user 190.

Server 110 and client devices 150 and 170 may also be capable of direct and indirect communication with additional computers on the network. Although only a few computers are depicted in FIGS. 1-2, it should be appreciated that a typical system can include a large number of connected computers, with each different computer being at a different node of the network 105.

The network, and intervening nodes, may comprise various configurations and protocols including the Internet, World Wide Web, intranets, virtual private networks, wide area networks, local networks, private networks using communication protocols proprietary to one or more companies, Internet relay chat channels (IRC), instant messaging, simple mail transfer protocols (SMTP), Ethernet, WiFi and HTTP, and various combinations of the foregoing.

Client devices 150 and 170 may include a component, such as circuits, to determine the geographic location and orientation of the device. For example, client device 170 may include a GPS receiver 189 to determine the device's latitude, longitude and altitude position. The component may also comprise software for determining the position of the device based on other signals received at the client device 170, such as signals received at a cell phone's antenna from one or more cell phone towers if the client device is a cell phone. It may also include an accelerometer 188 or gyroscope to determine the direction in which the device is oriented. By way of example only, the device may determine its pitch, yaw or roll (or changes thereto) relative to the direction of gravity or a plane perpendicular thereto.

In that regard, it will be understood that a client device's provision of location and orientation data may be provided automatically by such circuits.

Map database 270 of server 110 stores map-related information, at least a portion of which may be transmitted to a client device. For example, map database 270 may store map tiles (not shown), where each tile is a map image of a particular geographic area. Depending on the resolution (e.g., whether the map is zoomed in or out), one tile may cover an entire region such as a state in relatively little detail. Another tile may cover just a few streets in high detail. The map information is not limited to any particular format. For example, the images may comprise street maps, satellite images, or a combination of these, and may be stored as vectors (particularly with respect to street maps) or bitmaps (particularly with respect to satellite images). The various map tiles are each associated with geographical locations, such that the server 110 is capable of selecting, retrieving and transmitting one or more tiles in response to receiving a geographical location.

As further described below, a location may be expressed and requested in various ways including but not limited to latitude/longitude positions, street addresses, points on a map (such as when a user clicks on a map), building names, other data capable of identifying one or more geographic locations, and ranges of the foregoing.

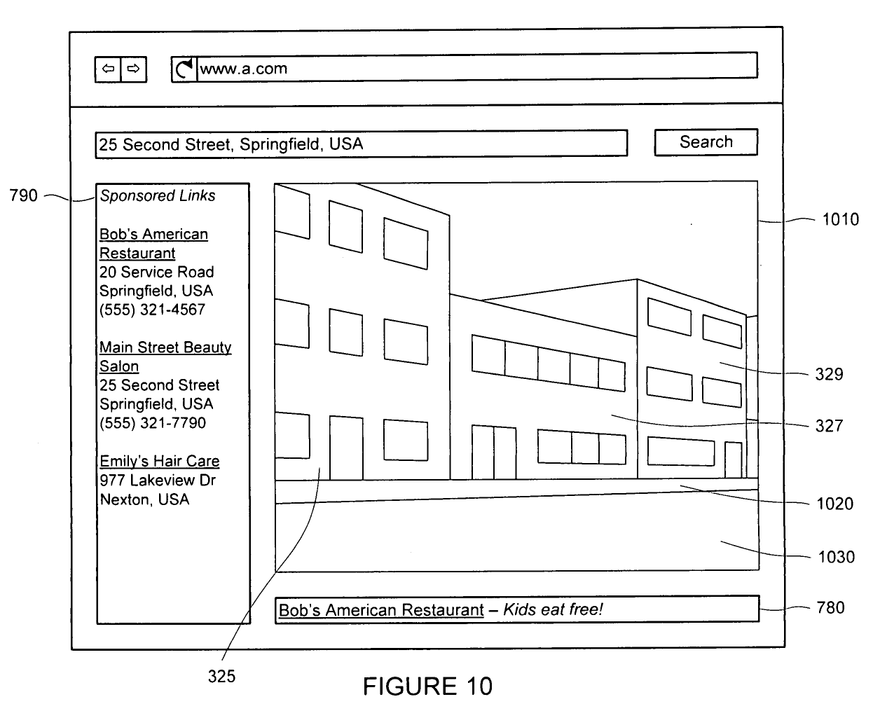

The server may also store street level images 275. A street level image is an image of geographic objects that was captured by a camera at an angle generally parallel to the ground. Both the geographic objects in the image and the camera have a geographic location relative to one another. Thus, as shown in FIG. 10, street level image data may represent various geographic objects such as buildings 325, 327, 329, sidewalk 1020 and street 1030. Street level image 1010 only shows a few objects for ease of explanation. However, a typical street level image will contain as many objects at geographic locations (street lights, mountains, trees, bodies of water, vehicles, people, etc.) in as much detail as the camera was able to capture.

The geographic objects in the street level images may be captured in a variety of different ways. For example, the street level image may be captured by a camera mounted on top of a vehicle from a camera angle pointing roughly parallel to the ground and from a camera position at or below the legal limit for vehicle heights (e.g., 7-14 feet). (Street level images are not limited to any particular height above the ground; a street level image may be taken from the top of building.) In addition to other ways, panoramic street-level images may be created by stitching together a plurality of photographs taken from different camera angles.

The camera may be any device capable of capturing optical images of objects including film cameras, digital still cameras, analog video cameras and image sensors (by way of example, CCD, CMOS or other).

Each street level image may be stored as a set of pixels associated with color and brightness values. For example, if the images are stored in JPEG format, the image will be displayed as a set of pixels in rows and columns, with each pixel being associated with a value that defines the color and brightness of the image at the pixel's location.

In addition to being associated with geographic locations, street level images 275 are typically associated with information indicating the orientation of the image. For example, if the street level image comprises a typical photograph, the orientation may simply be the camera angle such as an angle that is 30° east of true north and rises 20 from ground level. If the street level image is a panoramic image, such as a 360° panorama centered at the geographic location associated with the image, the orientation may indicate the portion of the image that corresponds with looking due north from the camera position at an angle directly parallel to the ground. In either case, the user may view the objects in the image from a perspective that is both located at the camera location and from an angle that corresponds with one of angles from which the camera captured the objects.

Street level images may also be stored in the form of videos, such as by displaying MPEG videos captured by an analog video camera or displaying, in succession, time-sequenced photographs that were captured by a digital still camera.

As explained in more detail below, a street level image may also be associated with information 221 that identifies orientation-specific search terms.

The server may also access listing information identifying local businesses or other objects or features associated with particular geographic locations. For example, each listing 210 may be associated with a name, a category (such as “pizza”, “Italian restaurant” or “ballpark”), other information (such as store hours and food on a menu) and a location. The information may be compiled by automatically gathering business information (such as from websites or telephone directories), or users may enter or edit the listing information themselves via web pages served by the server 110. The location may be stored as both a street address and a latitude/longitude position. It will be understood that in lieu of storing both locations, the latitude/longitude position may be calculated on-demand based on the street address, and vice versa, by the use of a geocoder or the like.

In many cases, there will be a single listing 210 in the map database 270 for each different business. However, it will be understood that the same business may be associated with many different listings, and that a single listing may be associated with many different businesses.

Listings may include other geographically-located objects in addition to or instead of businesses. For example, they may also identify individual's homes, landmarks, roads, bodies of land or water, the current position of a car, items located in a store, etc. Therefore, while many of the examples below refer to business listings, most aspects of the system and method are not limited to any particular type of listing.

The server may also store a set of advertisements 220. The advertisement is selected for provision to users based at least in part on whether it is returned in response to a query containing search terms. For example, a company may pay the operator of the server each time the content of the advertisement is displayed or selected by a user in response to the user searching for the keyword “pizza.” Search terms are typically text based, but may include other types of data including data representing images and sounds.

In one aspect and as shown in FIG. 1, the advertisements 220 may be directly or indirectly associated with geographic locations (such as being directly associated with a listing that is, in turn, directly associated with a geographic location). As noted more generally above, the system and method is not limited to any particular data structure. Accordingly, while FIG. 1 conveys the appearance of the advertisement being stored within the data of the listing, the data representing the advertisement may be associated with the listing in various ways such as via relationships between tables in different databases.

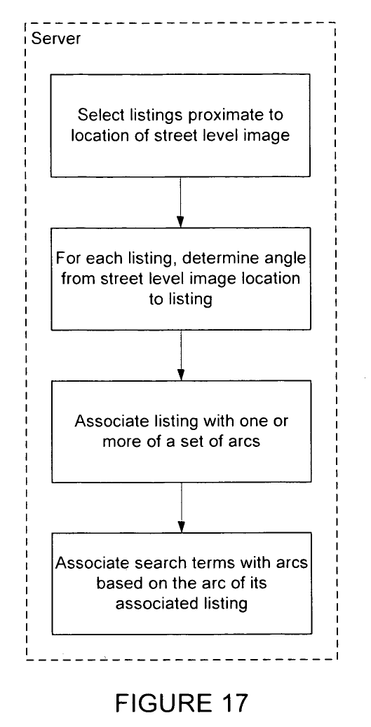

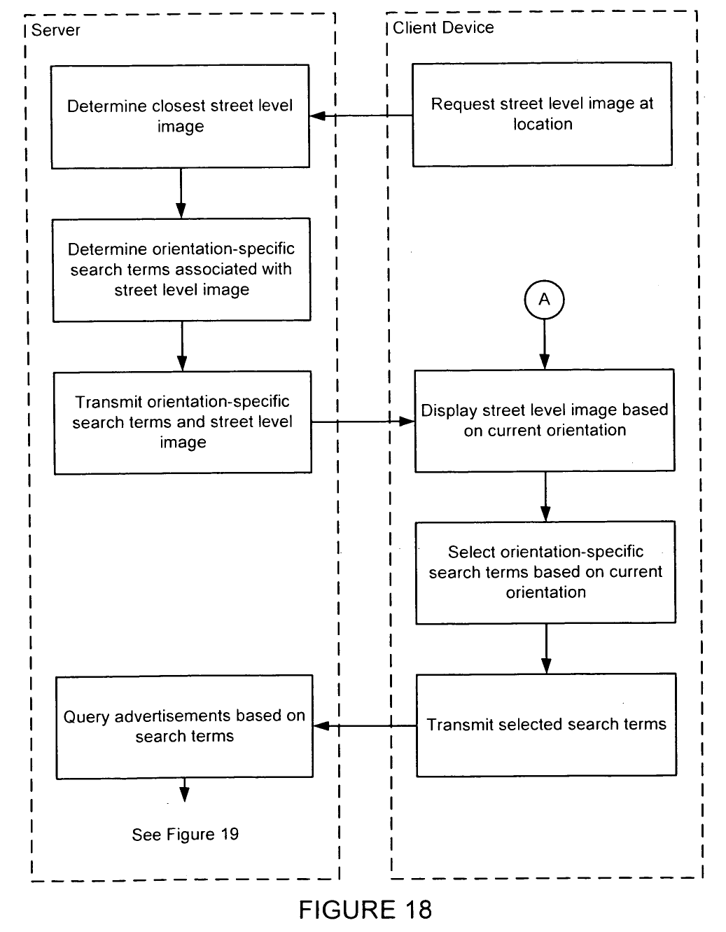

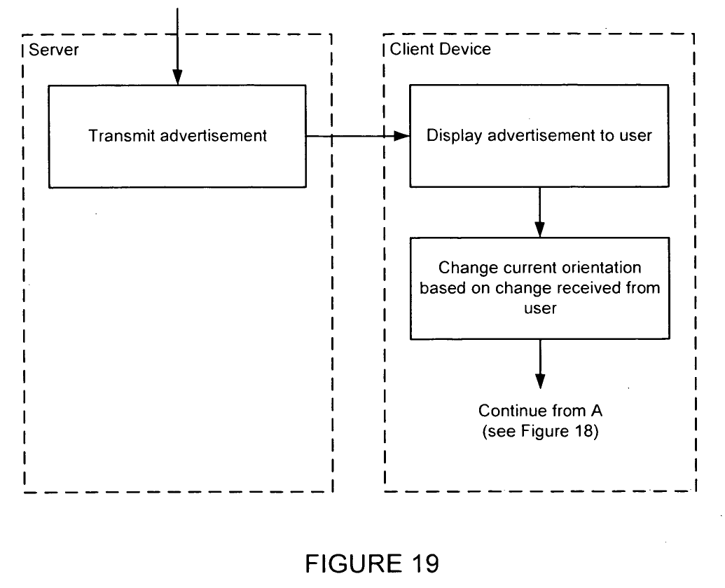

In addition to the operations illustrated in FIGS. 17-19, various operations in accordance with a variety of aspects of the invention will now be described. It should be understood that the following operations do not have to be performed in the precise order described below. Rather, various steps can be handled in reverse order or simultaneously.

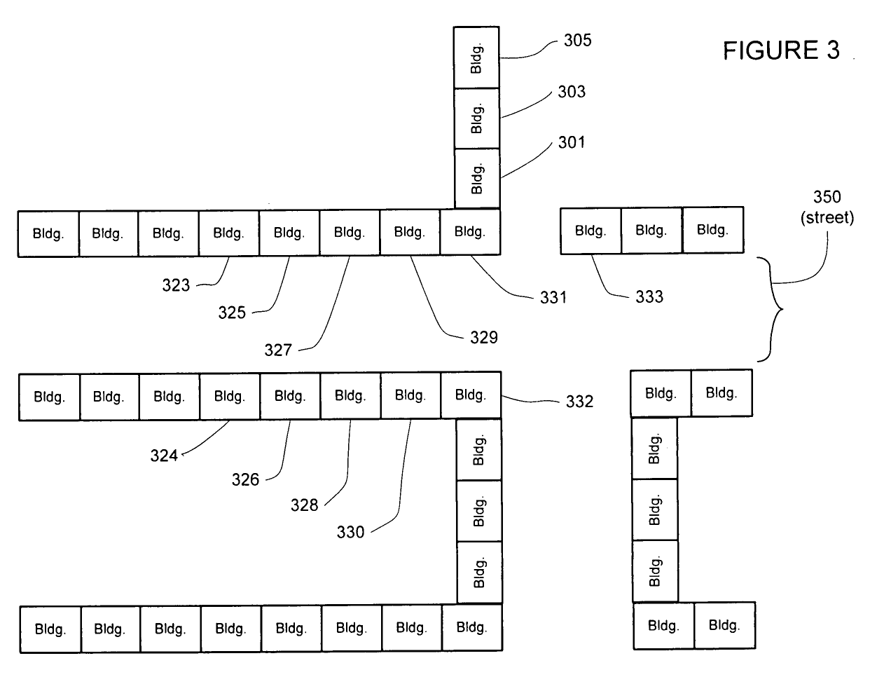

In one aspect of the system and method, the server associates a different set of search terms with different orientations. FIGS. 3-5 illustrate one aspect of determining such a set.

FIG. 3 illustrates the relative positions of buildings such as 301, 303, 305, and 323-333 along streets such as street 350. The buildings are associated with geographic locations, such as latitude/longitude locations and street addresses. For example, the street address of building 325 may be “25 Second Street, Springfield, USA.”

The street addresses of some of the buildings may be further associated with one or more listings.

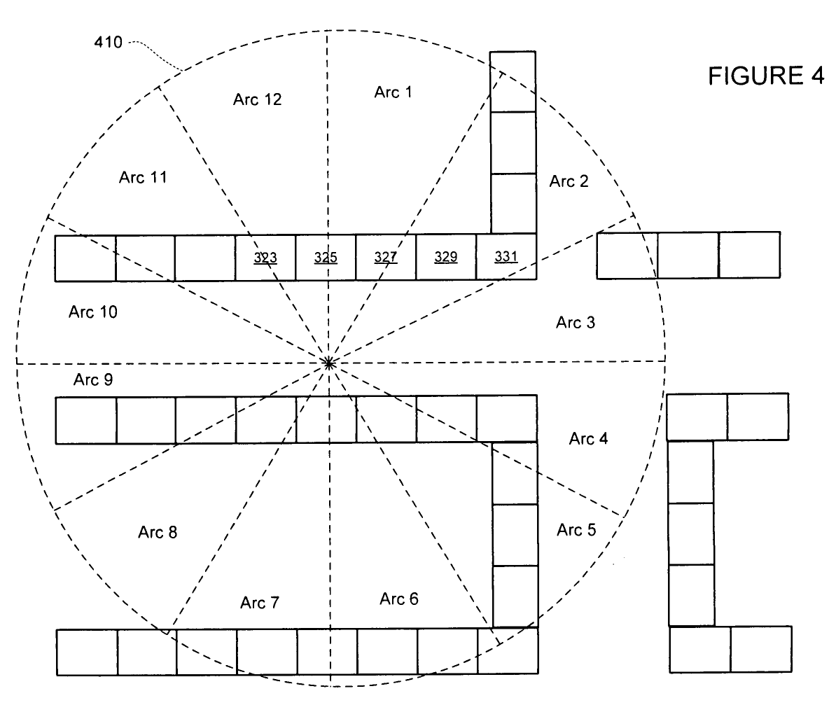

FIG. 4 illustrates the location of a street level image that was taken of the buildings 323-333. Specifically, the center of reference 410 illustrates the geographic location of the camera that captured the street level image.

In one aspect, the processor uses the camera location of the street level image and listings proximate to the location to create search terms that are associated with angles, or ranges of angles, relative to the location. For example, the server may associate all listings having locations within a certain range (indicated by the outer bounds of reference 410) of the camera location with one or more thirty-degree arcs 1-12. In that regard, Arc 1 may lie between a first angle at 0° and a second angle at 30°, and Arc 2 may lie between a first angle at 30° and a second angle at 60°.

Just one possible method of determining search terms comprises querying the listings 210 to find all listings within a given range of the latitude/longitude of the camera location. The server may then determine the azimuth angle, namely, the angle from a reference vector to a vector extending towards the latitude/longitude locations of each listing. The angle is then used to allocate the terms associated with the listing to a member of a set of angles ranges or arcs. For example, if the azimuth angle of a building is 15°, the listings associated with the buildings may be used to select search terms for Arc 1, which lies between 0° and 30°.

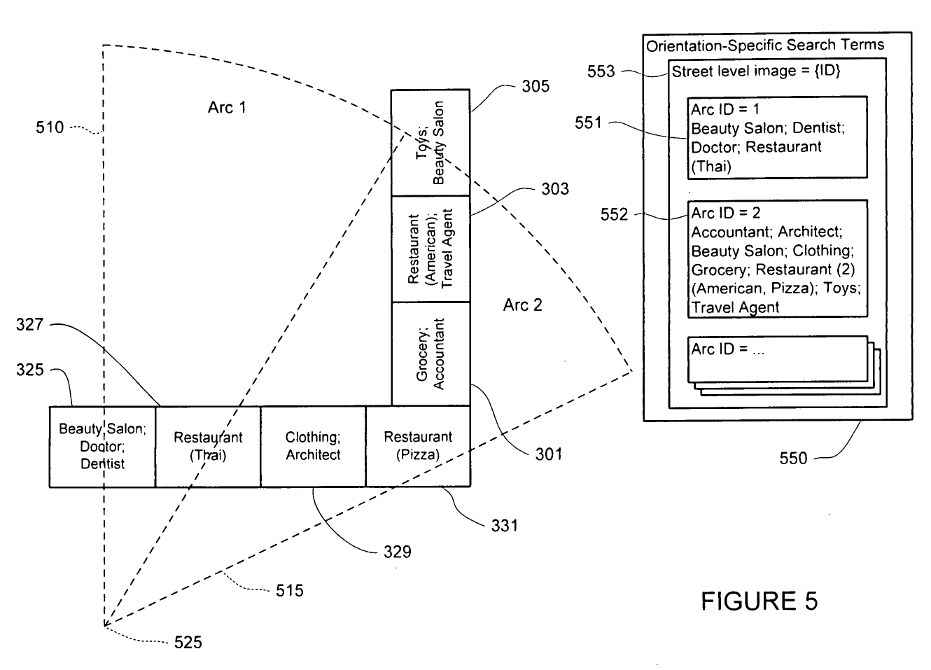

FIG. 5 shows two of the arcs and their associated search terms in more detail. The first arc 510 is defined by the first thirty degrees from North, such as all of the listings associated with buildings 325 and 327. In one aspect, the categories of such listings are used as the search terms and the categories of the listings of each building are shown in the figure. For example, the listing named “Main Street Beauty Restaurant” may be located at “25 Second Street” in building 325 and be associated with the category “Beauty Salon”. In that regard, the server stores an association 551 between categories such as “Beauty Salon, ” “Dentist,” “Doctor” and “Restaurant (Thai)” with the first arc 510 of the street level image 553.

The server may similarly determine and store associations 552 between the second thirty-degree arc 515 of the street level image and the categories of listings falling within the arc (namely, listings associated with the buildings 301, 303, 305, 329 and 331). The process may continue for the other arcs.

While the stored values are specific to orientations, it will be understood that the orientation-specific search terms may also be associated with geographic locations. For example, the orientation-specific search terms 551-52 are associated with both a range of angles (e.g., Arc 1) and a location (e.g., the camera location of the street level image).

As explained in more detail below, these terms may then be used to search for advertisements. As also noted below, the search terms may be based on terms other than the categories of the listings.

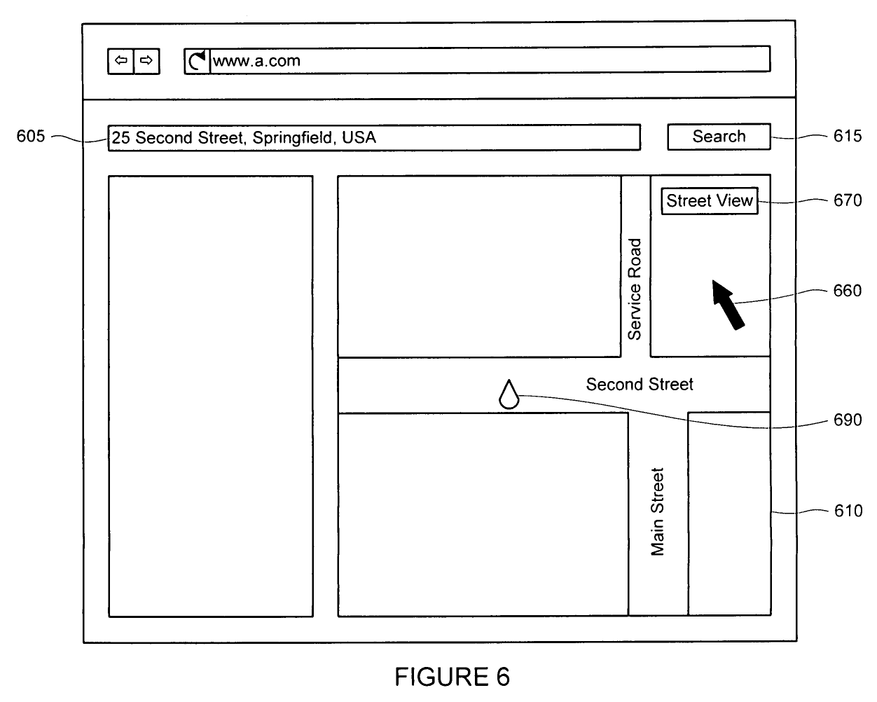

FIG. 6 provides an example of a screen shot that may be displayed by the display of a client device. For example, the system and method may be implemented in connection with an Internet browser such as Google Chrome displaying a web page showing a map 610 and other information. In addition to the browser program, the instructions executed by the client device may also include additional instructions such as Java script provided by server 110.

The system and method may provide the user with a great deal of flexibility when it comes to requesting a location to be shown in a street level view. For example, the user may enter text identifying a location in textbox 605 such as an address, the name of a building, or a latitude and longitude. The user may then transmit the location to the server by selecting search button 615. The user may further use a mouse or keypad to move a mouse cursor 660 to identify a particular geographical location on the map. Yet further, the program may provide a button 670 or some other feature that allows a user to request a street-level view of the geographic objects at the provided location.

In that regard, the street level image may be retrieved based on the location requested by a user. In one aspect, if the street level images are associated with discrete locations, the server will select the street level image that is associated with the latitude/longitude location closest to the latitude/longitude value provided by the user (or calculated based on a location provided in another reference system, such as street address or pixel position on a map).

When requesting a street level image, the map may indicate the location of the camera position and the orientation of the view with a viewpoint cursor 690. The orientation may be defined by the user or default to a particular orientation.

In addition to selecting the street level image, the system and method may also select the orientation-specific search terms associated with the street level image. For example, the server may send, to the client device, all of the orientation-specific search terms 550 that are associated with the street level image to be displayed. The data may be structured as a table, with each row corresponding with a different arc, one column identifying the range of the arc and another column identifying the search terms associated with the arc.

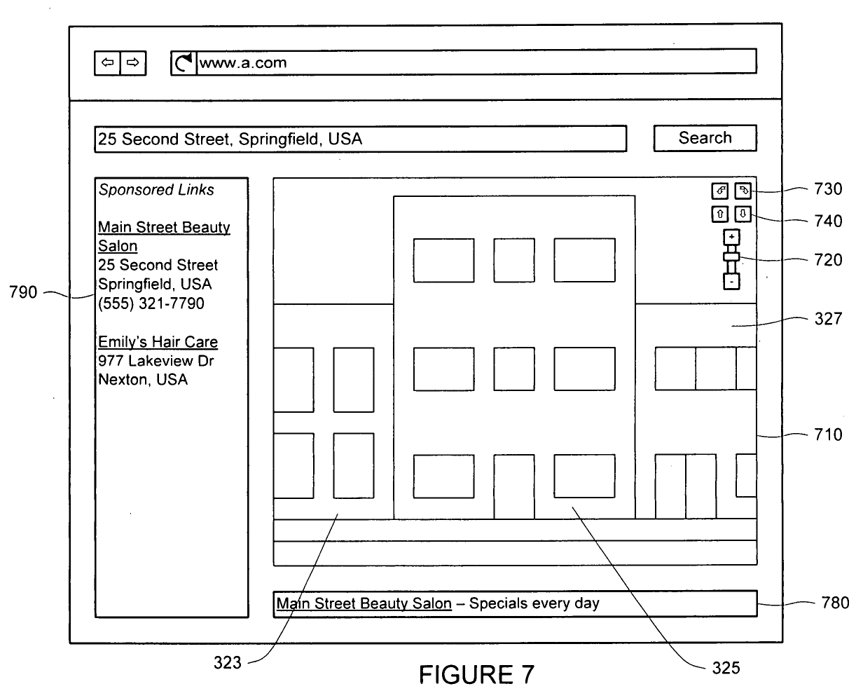

As shown in FIG. 7, the street level image 710 may be shown in the browser along with user-selectable controls for changing the location or orientation of the viewpoint. The controls may include controls 720 for zooming the image in and out, as well as controls 730 to change the orientation of the view, such as changing the direction from looking northeast to looking northwest. If the street level image was downloaded as an entire 360° panorama, changing the direction of the view may necessitate only displaying a different portion of the panorama without retrieving more information from the server. The street level image 710 illustrates a street level image that directly faces buildings 323, 325 and 327 in a northerly direction.

The user may also change the location of the viewpoint. For example, the user may move the viewpoint forwards or backwards in the currently-viewed direction by selecting controls 740. Depending on the street level image data that was downloaded, a change in location or orientation may necessitate the client device obtaining more street level image data from the server. Thus, changing locations may cause the client device to retrieve a different street level image and associated data.

Other navigation controls may be included as well, such as controls in the form of arrows disposed along a street that may be selected to move the vantage point up or down the street. A user may also operate the arrow controls of a keyboard to change the zoom, direction or location of the view. A user may further select portions of the image, such as by moving and clicking a computer mouse or tapping a touch-sensitive screen, to select and move closer to the objects displayed in the image.

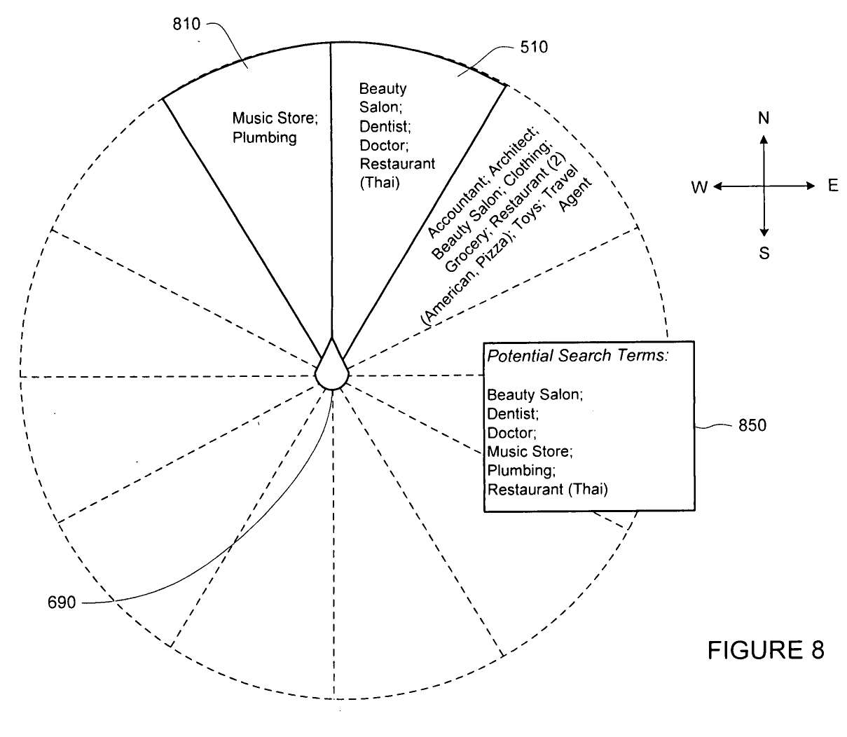

In one aspect of the system and method, search terms are selected based on the orientation used to display the street level image to the user. For example, FIG. 8 shows an alternative representation of the orientation-specific search terms 550 shown in FIG. 7. The search terms in arc 510 correspond with the first arc extending away from the street level image's location. The terms in arc 810 correspond with the twelfth arc. (It will be understood that the other arcs may or not include search terms.) Assuming that the orientation used to view the street level image is due north as indicated by cursor 690, the view will include both first arc 510 and twelfth arc 810. Accordingly, all or some of the search terms in both the first and twelfth arcs may be used to select an advertisement. Continuing the prior example, the Selected search terms 850 thus include “Beauty Salon; Dentist; Doctor; Restaurant (Thai)” and “Music Store; Plumbing”.

Once the orientation is known, the client device may transmit the selected orientation-specific search terms to the server.

The orientation-specific search terms may be used to select an advertisement. By way of example only and in one aspect, the server may query listings 210 for all advertisements 220 that both (1) have a keyword corresponding with one of the search terms 850 and (2) are associated with a listing 210 within a geographic range of the street level image's location. (The range used to select ads may be greater, less than or equal to the range used to compile the search terms.) In that regard, an advertisement associated with “Main Street Beauty Salon” at “25 Second Street, Springfield” may be selected as the highest-ranking advertisement and an advertisement for “Emily's Hair Care” at an address in a neighboring town (“Nexton”) may be selected as the second-highest ranking advertisement.

As noted below, other methods may be used to select advertisements as well, such as querying an advertisement database where the advertisements of the database are not associated with a listing but are associated with keywords and a particular location. In that regard, advertisements may be queried based on a correspondence between the orientation-specific search terms and keywords and the proximity of the advertisement's location to the street level image's location.

The advertisement may be displayed to the user, such as but not limited to being displayed simultaneously with and adjacent to the street level image. For example, as shown in FIG. 7, the server may send the highest ranking advertisement to be shown on the client device's display as a single line of text 780 in the browser window. The advertisement may include both the listing's name (“Main Street Beauty Salon”) and other content (“Specials every day”). The same and other advertisements may also be shown to the user such as in box 790 to the left of the street level image. In addition to text, it will be understood that the advertisement's content may also comprise other types such as images and sounds.

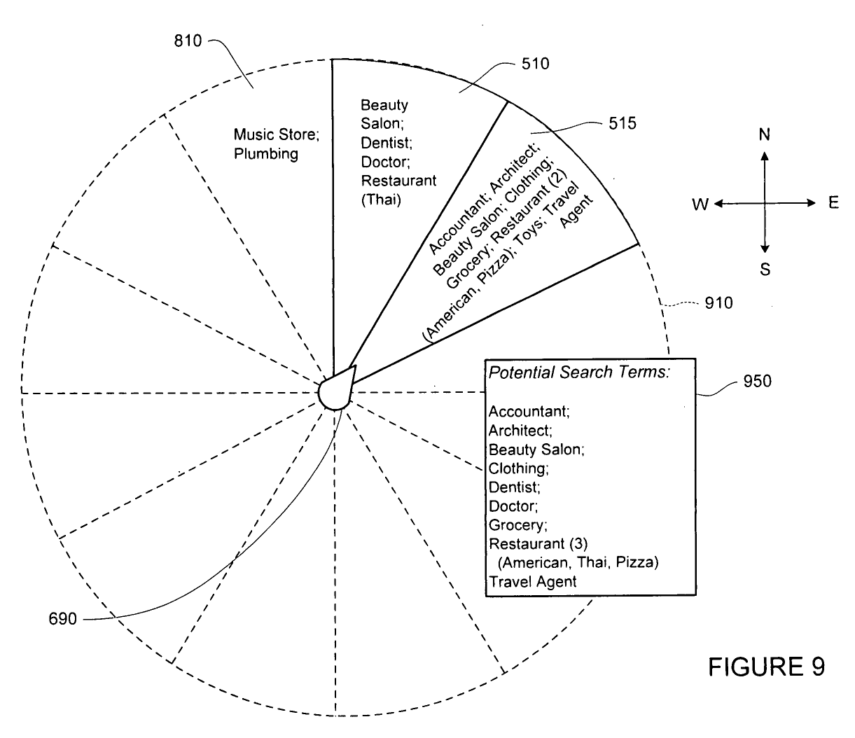

As noted above, the client device may provide user-selectable controls for changing the location or orientation of the viewpoint. Even if the location of the street level image does not change, the advertisements that are displayed along with it may change as the image's orientation changes. For example, as shown in FIG. 9, the orientation (as indicated by cursor 690) may change to a direction that is closer to northeast than north. As such, the view is likely to include at least first arc 510 and second arc 515. It may also include third arc 910 as well.

Accordingly, the potential search terms used to select advertisements may change as the orientation changes. The selected search terms 950 associated with the northeast orientation may include some of the same terms as before such as “Beauty Salon; Dentist; Doctor; Restaurant (Thai)”. However, it may also include new terms such as “Accountant; Architect; Beauty Salon; Clothing; Grocery; Restaurant (American); Restaurant (Pizza); Toys; Travel Agent”.

When the new search terms are used to query the advertisements, new advertisements may be returned. FIG. 10 provides an example of a new field of view that includes some of the prior view, such as building 325 and 327. Although “Main Street Beauty Salon” continues to match one of the search terms, there may be higher-ranking advertisements. For example, an advertisement for “Bob's American Restaurant” may rank higher based on the introduction of the search term “Restaurant (American)” and the popularity of the restaurant's website. Accordingly, as illustrated in FIG. 10, when the browser shows the street level image 1010 from a new orientation, the advertisement in box 780 may display the advertisement for the restaurant in lieu of the beauty salon. The box 790 may display all or some of the responsive ads as well, including the advertisement for the restaurant (which may be displayed at the top in view of its rank) as well as the responsive ads for the beauty salons.

The advertisements may not necessarily change with each change in orientation. For example, if the search terms are associated with directions that are spaced many degrees apart, and if the orientation only changed a few degrees, the change may not implicate a different set of search terms.

One of the advantages of the system and method is its ability to include many possible alternatives.

For example, the relative size of the arcs may be larger or smaller than indicated above. While the arcs may be any size, arcs between 45° and 120° may be particularly advantageous in certain circumstances with respect to finding the most prominent matches within a particular field of view. While arcs of fixed size may ease processing, not all of the arcs associated with a street level image need to be the same size.

In other aspects of the system and method, a search term may be included in more than one arc (e.g., its building extends into two arcs). Yet further, arcs may overlap. For example, the table sent to the client device may include two levels of arcs, with one level defining 90° arcs and the other defining 45° arcs.

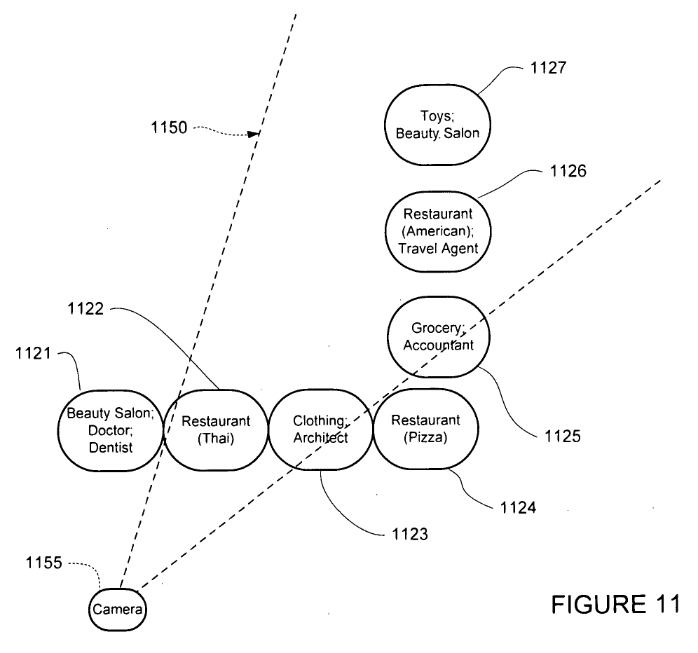

Although pre-associating search terms with fixed ranges of orientation angles can provide particular advantages, other aspects of the system and method do not predefine orientation ranges. FIG. 11 illustrates the geographic positions 1121-27 of listings relative to the camera location 1155 of a street level image. The text values represent listing categories. The figure also illustrates the orientation 1150 of the view, that is, the bounds of viewable geographical area if the view was completely unobstructed.

In the aforementioned aspect, the client device may transmit the angle and width of the orientation to the server. Because the latitude/longitude of the camera location 1155 is known, the server may query listings 210 within a certain distance and falling within the bounds of the view 1150. The categories associated with the returned listings, such as 1122-23 and 1125-27, may then be used to select the search. While potentially more processing intensive than the aforementioned aspect of associating search terms with ranges of angles prior to receiving orientations set by users, this aspect may yield more targeted advertisements in a particular set of circumstances.

The angle between the bounds (i.e., whether the view is wide or narrow) may depend on parameters set by the user, such as the pixel height/width ratio of the street level image to be displayed. The height and width of the street level image may in turn depend on the height and width of the browser.

The system and method may also obtain keywords from sources other than listing categories. For example, if listings are used as the source of the keywords, any information associated with the listings may be used. This may include information directly associated with the listing such as the name and category. It may also include information more indirectly associated with the listing such as previous search terms used to locate the listing. For example, prior users may have previously searched for “calzones” and consistently selected the restaurant at location 1124 over other search results. If so, the system and method may also use the keyword “calzones” to select advertisements when the orientation is in the direction of location 1124.

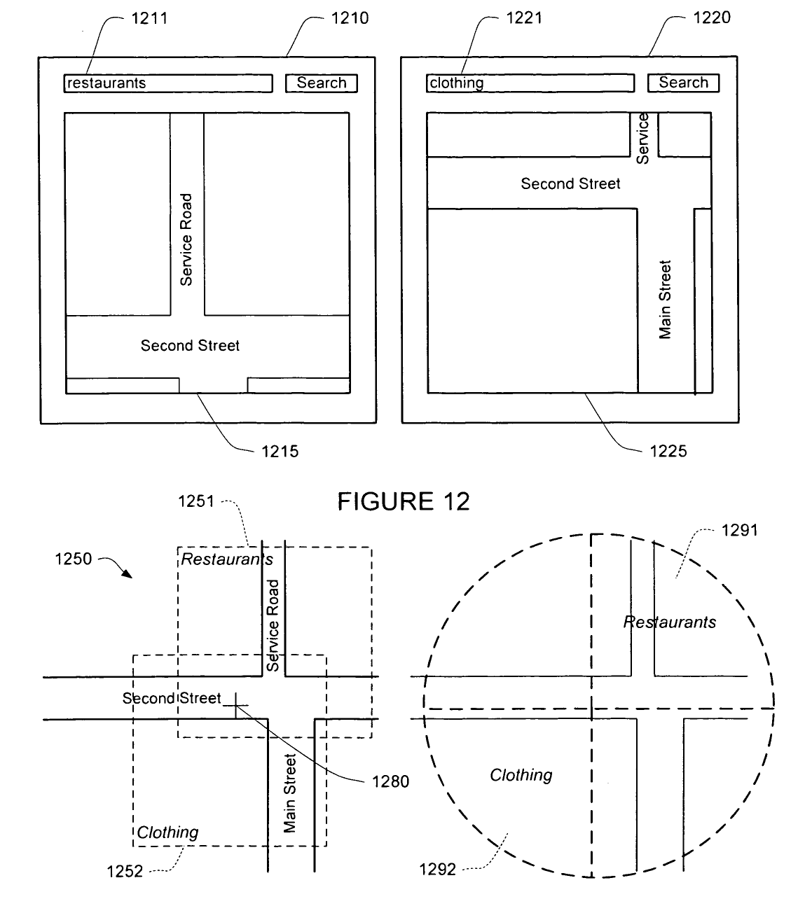

Orientation-specific search terms may also be compiled from sources that are not specific to individual listings. For example, the source may comprise search terms that prior users selected when viewing areas of a map. FIG. 12 illustrates screen shot 1210 of a browser displayed to a user. In the instance of screen 1210, a user searched for “restaurants” (by typing the word in text box 1211) while viewing a map 1215 of the northeastern portion of map 1250. Similarly, screen shot 1220 illustrates a second instance where a user searched for “clothing” (by typing the word in text box 1221) while viewing a map 1225 of the southwestern portion of map 1250.

Map 1250 shows the center position of a street level image 1280 relative to the map. As shown on map 1250, the geographic area 1251 associated with the “restaurants” search is generally northeast of the street level image location 1280, and the geographic area 1252 associated with the “clothing” search is generally southwest of the location. Accordingly, the server may determine that the search terms “restaurants” and “clothing” may be associated with a northeast arc 1291 and a southeast arc 1292, respectively, extending from the street level image location.

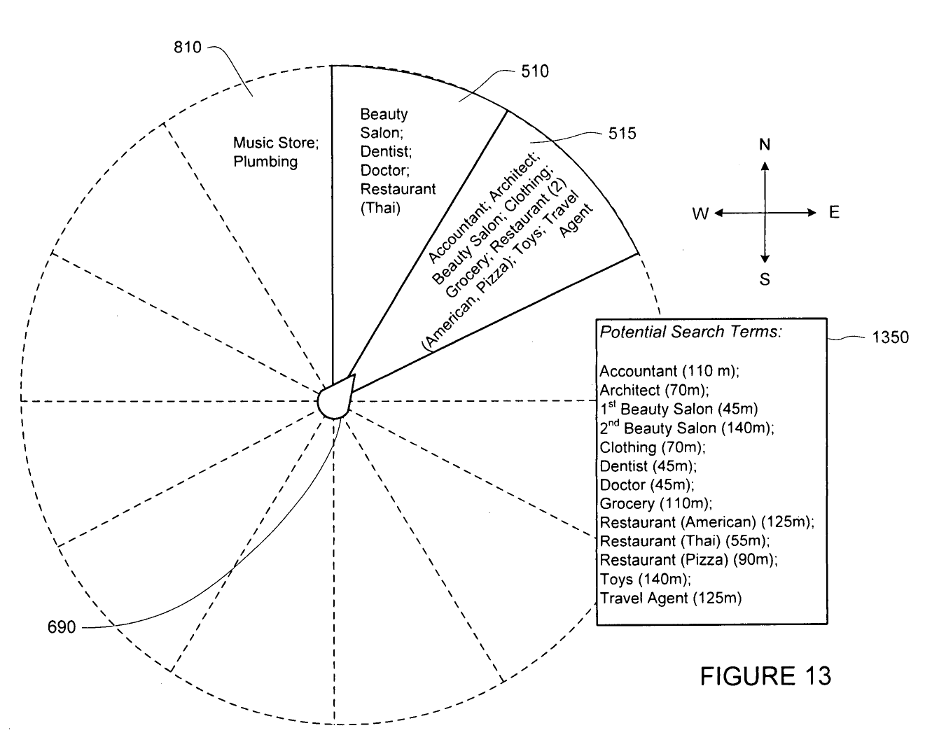

In addition to using all applicable keywords from multiple sources, the keywords may also be selected based on various criteria. FIG. 13 shows the same listing categories as FIG. 9. As noted before, the categories may be selected based on their correspondence with the angle used to the view street level image. However, as indicated in the list 1350 of potential search terms, each term may also be associated with a value that reflects a distance to the geographic location of the street level image. For example, the accountant's listing may indicate an address that is 110 meters from the location of the camera when the street level image was captured.

In one aspect, the system and method only queries advertisements based on the closest listing(s) to the street level image location. For example, the system and method may select only the three closest terms, such as “beauty salon”, “dentist” and “doctor”. (FIG. 13.)

Alternatively, rather than selecting a limited number of search terms based on distance or any other criteria, the search terms may be accorded weights. For example, when querying advertisements, the term “Toys” may be accorded half as much weight as “Architect” because the toy store is twice as far away as the architect.

Terms may also be accorded more or less weight depending on the number of listings associated with the term within the arc. For example, if the orientation indicated that the street level image was facing in the direction of many restaurants but only one clothing store, the term “restaurant” may be accorded more weight than “clothing.”

Even so, advertisements (such as those associated with the keyword “toys”) may still be selected over advertisements associated with terms that are geographically closer (such as “architect”) or more plentiful (such as “restaurant”) due to other criteria. For example, the customer of the toy advertisement may be more prominent than the customers associated with the architect or restaurant such as web site prominence.

As noted above, advertisements also may be selected based on criteria beyond how well their keywords correspond with the orientation-specific search terms. For example, the advertisements may be ranked based on a formula that depends on a number of parameters such as: how well the advertisement's keywords match the orientation-specific search terms; how well the advertisement's keywords match other search terms entered by a user; the relative prominence of a website associated with the advertisement (e.g., the number of back links and visitors to the site); the price to be paid for the advertisement; the relative frequency that the advertisement is selected by users; etc.

Yet further, the advertisements may be associated with different types of queryable locations. For example, advertisements may be associated with geographic locations but not necessarily location-based listings. In that regard, a customer may enter advertising content and keywords and indicate an area of a map that corresponds with the advertisement—regardless of whether the customer has a listing associated with the area. The advertisement may then be stored in a database.

When the database is queried for display to a user, an advertisement may be selected based on both the orientation-specific search terms and whether the user is viewing a street level image or map that overlaps with the advertisement's area.

In another aspect, the advertisement may not be associated with a location at all. While the user's currently-viewed location and orientation may be used to select the keywords that are used to select the advertisement, the advertisement may be location neutral. For example, a customer may enter advertising content and a keyword such as “pizza” without limiting the advertisement to any specific area. If the orientation-specific search term is “pizza”, the customer's advertisement may be selected regardless of the fact that it is not associated with a location.

In still another aspect, the association of an advertisement with a location is a factor, but not necessarily dispositive, of whether the advertisement is selected. For example, four different customers may have all associated their advertisements with the keyword “pizza,” but otherwise differ with respect to various location criteria: Customer A has may have a listing in the town of Springfield and limited its advertisement to the town of Springfield; Customer B may have no listing in the town but limited its advertisement to the town; Customer C may have a listing in the town but did not limit its advertisement to the town; and Customer D may have neither a listing in the town nor limited its advertisement to the town.

Accordingly, if a user is oriented directly towards a pizzeria in Springfield and the selected orientation-specific search term is “pizza”, the advertisement may be selected at least in part on the manner in which the advertisement is associated with the currently-viewed location. For example, Customer A's advertisement may be twice as likely to be selected as Customer B's , Customer B's advertisement may be twice as likely to selected as Customer C, and the like. (Again, however, Customer A's advertisement may not necessarily be selected over the other three depending on other factors such as price and the customers' prominence.)

The terms used to query the advertisement may further be based on the visibility of geographic objects within the street level image. The visibility of the surfaces of geographic objects within the street level image's field of view may be determined using a number of different methods. For example, at the same time the street level image is captured by a camera, a laser range finder may determine the distance between the camera and hundreds of points in a variety of horizontal and vertical directions. If the camera's latitude/longitude/altitude location is known (e.g., based on GPS), and if the distance, horizontal angle and vertical angle to a point on a surface of a geographic-object is known (e.g., based on the range finder and direction of the range finder), the latitude/longitude/altitude location of the point may also be determined. A geocoder may be used to correlate the latitude/longitude/altitude locations of the visible surfaces with street addresses.

The surface data may then be used to determine which street addresses are associated with buildings that are visible in the street level image.

Search terms taken from listings in buildings that visible from the camera location may be given greater weight than listings that are associated with buildings that are not. In one aspect, keywords for the selection of advertisements are themselves selected only if they are associated with businesses or other listings that are visible within the street level image at the given orientation. In another aspect, the advertisements themselves are selected based on their association with businesses or other listings that are visible at the given orientation.

In still another aspect, visibility of a geographic object at a particular location—and the amount thereo—is just one factor relating to the weight applied to search terms derived from the geographic object.

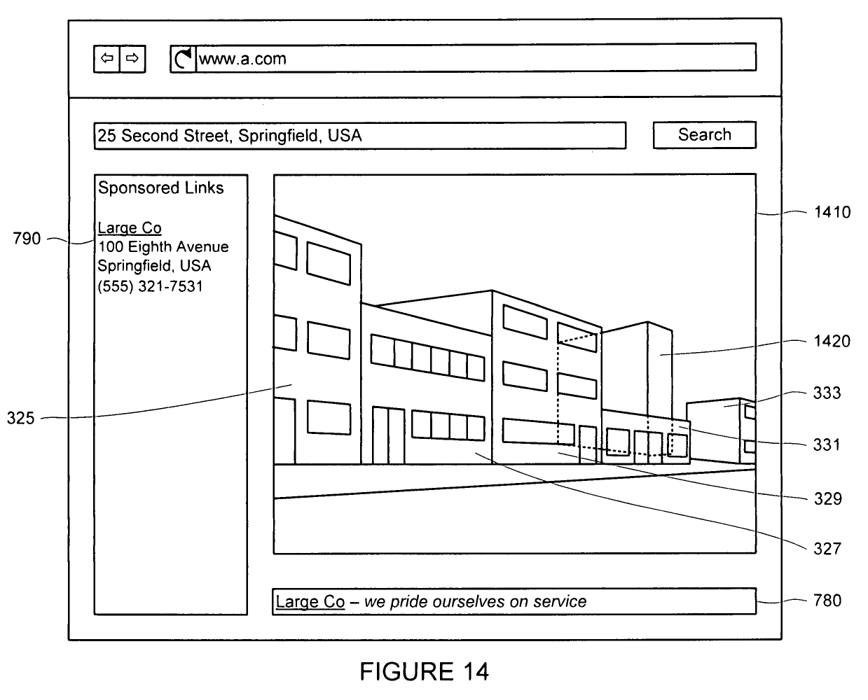

For example, both distance and visibility may be factored into advertisement selection. Based on the viewing angle shown in FIG. 10, the surface of building 329 essentially completely obscures any buildings that may be behind it. However, when the orientation is changed yet a little more easterly as shown in FIG. 14, a distant building 1420 comes into view. As indicated by the dotted imaginary lines, half of building 1420 may be obscured by building 329 (and was completely obscured in the orientation of street level image 1010), but it is at least partially visible in street level image 1410. Accordingly, terms derived from listings associated with distant building 1420 may be provided less weight than the listings from nearby building 329.

If a company associated with a distant building is very prominent, such as “Large Co.”, search terms based on the company (such as its listing) may be accorded more weight than search terms that would have been selected based on closer geographic objects. However, when the distance to the street level image camera location is factored in as described, the search terms associated with building 329 may be given greater weight.

As noted above, an advertisement may also be selected based on a number of weighted factors. As also noted above, one factor may be an object's distance from which the object is being viewed (e.g., camera location).

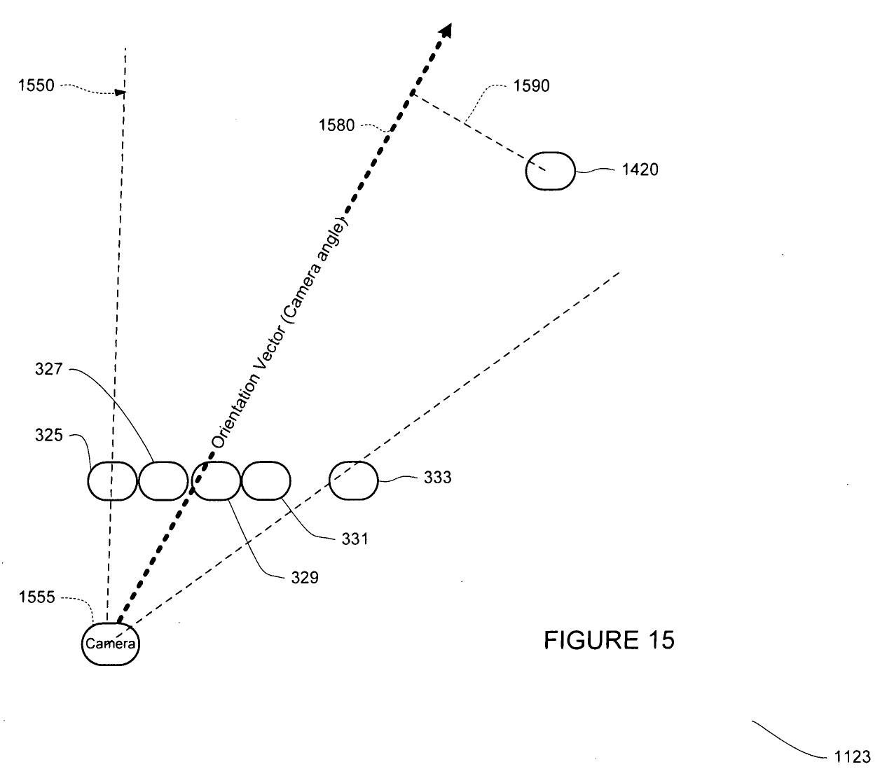

Yet another factor may be how close the search term's geographic location is to the center of the street level image at the applicable orientation. FIG. 15 illustrates the relative positions (indirectly to scale) of the buildings visible in street level image 1410, namely, buildings 325, 327, 329, 331, 333 and distant building 1420. Bounds 1550 define the left-most and right-most edges (e.g., the width) of the field of view. Orientation vector 1580 defines the angle from which the buildings are being viewed. The vector originates at the location 1555 from which the buildings are being viewed.

Whether a listing is close to the center of the street level image when viewed at a given orientation may be determined based on the listing's geographic distance to the orientation vector. The distance may be calculated from a variety of known quantities including the location of the base of the vector (e.g., the latitude/longitude position of the camera when the street level image was captured), the vector's angle (e.g., the camera angle) and the location of the listing (e.g., the latitude/longitude position of the listing).

In that regard, the distance 1590 between building 1420 and orientation vector 1580 is greater than the distance between building 329 and the orientation vector. In one aspect of the system and method, search terms derived from building 1420 may thus be accorded less weight than search terms from building 329.

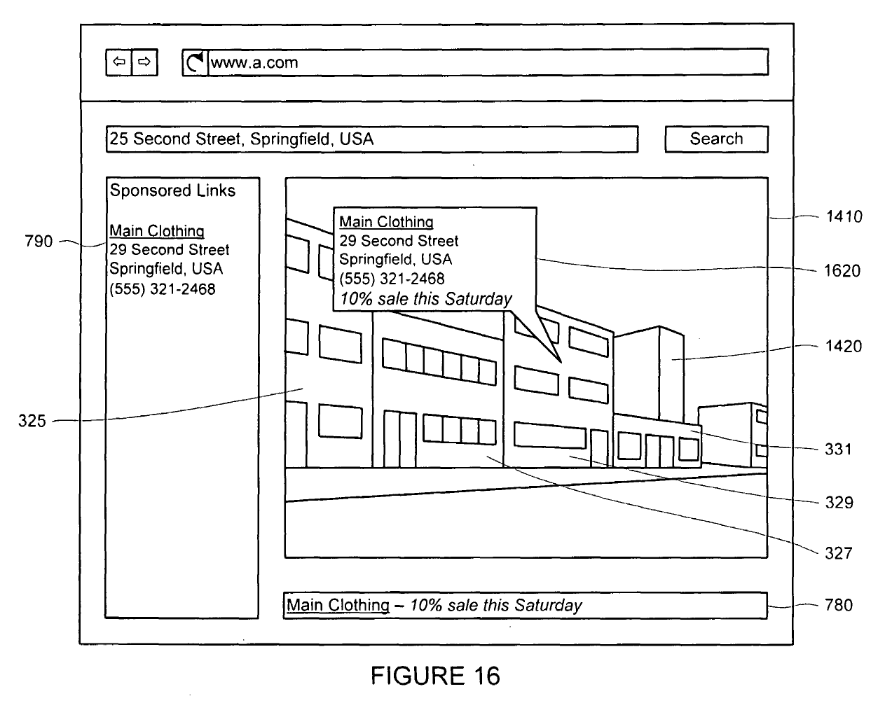

FIG. 16 illustrates an advertisement that may be displayed using the same criteria as that used in FIG. 14 plus the additional criteria of being centered in the street level image and visible. Compared to search terms derived from a more-prominent business located in building 1420, the search terms selected from a listing for a relatively-obscure clothing store in building 329 may be accorded more weight if the building is closer, more centered and more visible than building 1420. As a result, an advertisement of a clothing store may be shown in boxes 780 and 790 instead of an advertisement for the more prominent business. FIG. 16 illustrates the additional feature of showing an advertisement 1620 directly on the street level image with a pointer to the building containing the advertising company.

In still another aspect, information contained in the image may also be used. By way of example only, the street level image may be scanned for text (such as by OCR). If a building is associated with two listings, one prominent (e.g., the headquarters of a conglomerate) and the other obscure (e.g., a restaurant on the base floor), more weight may be given to the obscure listing if the street level image is oriented towards the text of the obscure listing (e.g., the street level image is zoomed in on the restaurant's clearly visible street sign as compared to the conglomerate's name on the top of the building).

In still a further aspect and rather than selecting search terms for advertisements, the system and method may also be used to select advertisements directly. For example, the system and method may select an advertisement based solely on its location's distance to the orientation vector and its distance to the camera location of the street level image.

The system and method may also be used to select descriptions of products and services, or descriptions of any other items, other than paid advertisements. For example, if some of the orientation-specific search terms were music related, the system and method may provide a description of local bands, local music venues or location-neutral music information such as song titles.

In other aspects, functions described above as being performed by the server may be performed by the client device, and vice versa. For example, the client device may transmit a request to change the orientation and receive a web page containing an advertisement in response; all of the determinations relating to the selection of the advertisement being performed by the server. Alternatively, the server may include a table where each row comprises a search term (or actual advertisement or other information to be displayed), a distance and an angle. The client device would then perform the calculations necessary to select the search terms (or advertisements or other information). In yet more aspects, the client device and server perform and share different functions.

As noted above, the client device may be a wireless phone. In one aspect, the location and angle that is used to select orientation-specific search terms depends on the geographic location and orientation of the phone. Accordingly, as the user changes locations or changes the orientation of the phone, different search terms may be used to query and display advertisements. In that regard, the phone may display advertising that corresponds with the direction in which the phone is pointing and changes as the position and orientation of the phone changes. The phone's location and angle may also be used to select and simultaneously display street level images that were captured at a corresponding location and orientation, such as displaying the appropriate portion of a 360 degree panoramic image that was captured at a nearby location. Yet further, the phone may display other information that may be associated with the street level image or the objects captured in the displayed portion of the image.

Most of the foregoing alternative embodiments are not mutually exclusive, but may be implemented in various combinations to achieve unique advantages. As these and other variations and combinations of the features discussed above can be utilized without departing from the invention as defined by the claims, the foregoing description of the embodiments should be taken by way of illustration rather than by way of limitation of the invention as defined by the claims. It will also be understood that the provision of examples of the invention (as well as clauses phrased as “such as,” “including” and the like) should not be interpreted as limiting the invention to the specific examples; rather, the examples are intended to illustrate only one of many possible embodiments.

1. A method of providing advertisements for display comprising:
receiving a request from a user;
in response to the request, providing an image to be displayed on an electronic display associated with the user, the image comprising geographic objects captured by a camera at a camera location;
selecting, with a processor, a search term from among a plurality of search terms based on the orientation angle from which the geographic objects are viewed relative to the objects' geographic locations;
selecting, with a processor, an advertisement based on the selected search term; and
providing the advertisement to be displayed on the electronic display.

2. The method of claim 1 wherein the image is a street level image.

3. The method of claim 2 wherein the image is a panoramic view of the geographic objects, only a portion of the image is displayed, and the displayed portion corresponds with the orientation angle.

4. The method of claim 1 wherein the search terms are selected from listings associated with listings proximate to the camera location.

5. The method of claim 4 wherein the listings comprise businesses having locations proximate to the camera location.

6. The method of claim 1 wherein each of the plurality of search terms is associated with an angle range and wherein selecting the search term comprises selecting a search term that is associated with the angle range that corresponds with the orientation angle.

7. The method of claim 1 wherein each of the plurality of search terms is associated with at least one of a plurality of angle ranges, and wherein selecting the search term comprises selecting a search term that is associated with an angle range that corresponds with the orientation angle.

8. The method of claim 1 wherein each angle range extends from a first angle to a second angle, and wherein a search term associated the angle range is selected if the orientation angle is more than equal to the first angle and less than equal to the second angle.

9. The method of claim 8 wherein the difference, measured in degrees, between the first and second angle of each angle range is the same for each angle range among the plurality of angle ranges.

10. The method of claim 8 wherein the difference between the first and second angle of each angle range is between 45° and 120°.

11. A system comprising:
a first computer at a first node of a network, the first computer comprising a processor and instructions operable by the processor;
the processor of the first computer having access to a plurality of street level images where each street level image is associated with a location, and the processor also has access to a plurality of keywords where each keyword is associated with a geographic location; and
a client device at a second node of the network, the device comprising a user input device, an electronic display, a processor and instructions operable by the processor;
the instructions of the first computer comprising transmitting, to the client device via the network:
a street level image, and
an advertisement selected based on the keywords, wherein the keywords were selected based on whether their location is proximate to the location of the street level image and whether their location corresponds with a viewing angle selected by a user at the second node to view the street level image; and
the instructions of the first computer comprising displaying, on the electronic display:
the street level image transmitted by the first computer, and
the advertisement transmitted by the first computer.

12. The system of claim 11 wherein the network is the Internet.

13. The system of claim 11 wherein the first computer is a web server.

14. The system of claim 11 wherein the client device is a mobile phone.

15. The system of claim 11 wherein the client device is a personal computer.

16. The system of claim 11 wherein:
the instructions of the first computer further comprise transmitting a set of keywords and orientation data to the client device, where the orientation data is related to the location of the search term relative to the location of the street level image; and
the instructions of the client device further comprise selecting, with the processor, a keyword based on a correspondence between the viewing angle and the orientation data, and transmitting the selected keyword to the first computer.

17. The system of claim 16 wherein the orientation data comprises a table associating the keywords with angles.

18. The system of claim 17 wherein the orientation data comprises associating each keyword with one of a plurality angle ranges.

19. The system of claim 11 wherein the advertisement is associated with a location and the advertisement is further selected based on proximity of the advertisement's location to the street level image's location.

20. A method comprising:
displaying an image of geographic objects on an electronic display from a viewing perspective, where the viewing perspective identifies both the location and angle from which the objects are shown in the display;
selecting, with a processor, a portion of a set of search terms based on a comparison of the viewing perspective with location information associated with each search term; and
displaying a description simultaneously with the image of geographic objects, where the selected description was selected from among a plurality of descriptions based on the selected search terms, and where each description is associated with at least one search term.

21. The method of claim 20 wherein the angle of the viewing perspective is selected by a user via a user input device.

22. The method of claim 21 wherein the orientation is selected by orienting a portable device.

23. The method of claim 22 wherein the portable device is a wireless phone.

24. The method of claim 20 wherein the location of the viewing perspective is the location of a camera used to capture the image of the geographic objects.

25. The method of claim 24 wherein the location of the camera is expressed in latitude/longitude coordinates.

26. The method of claim 24 wherein the angle of the viewing perspective is the angle of a camera used to capture the image of the geographic objects.

27. The method of claim 20 wherein the selected description is an advertisement.

28. The method of claim 20 wherein at least a portion of the set from which the search terms are selected are based on terms associated with businesses, and wherein the locations of such search terms correspond with the location of such businesses.

29. The method of claim 28 wherein at least one search term is based on the name of the business.

30. The method of claim 28 wherein at least one search term is based on the category of the business.

31. The method of claim 20 wherein a search term is selected if its location falls within the field of view of the displayed image.

32. The method of claim 20 wherein a search term is further selected based on whether the search term is associated with a building that is visible in the displayed image.

33. The method of claim 20 wherein the search term is further selected based on the proximity of the search term's location to the location of the viewing perspective.

34. The method of claim 20 wherein the search term is further selected based on the distance from the search term's location to a vector defined by the location and angle of the viewing perspective.

35. The method of claim 20 wherein the search term is associated with a listing and the search term is further selected based on the prominence of the listing.

36. A computer usable medium including a program comprising:
computer code that displays an image of geographic objects on an electronic display from a viewing perspective, where the viewing perspective identifies both the location and angle from which the objects are shown in the display;
computer code that selects a portion of a set of search terms based on a comparison of the viewing perspective with location information associated with each search term; and
computer code that displays a description simultaneously with the image of geographic objects, wherein the selected description was selected from among a plurality of descriptions based on the selected search terms, and where each description is associated with at least one search term.

37. A computer usable medium including a program comprising:
computer code-that receives a request from a user;
computer code that provides an image to be displayed on an electronic display associated with the user in response to the request, the image comprising geographic objects captured by a camera at a camera location;
computer code that selects a search term from among a plurality of search terms based on the orientation from which the image will be viewed by the user;
computer code that selects an advertisement based on the selected search term; and
computer code that provides the advertisement to be displayed on the electronic display.
